(19) United States
(12) Patent Application Publication
(10) Pub. No.: US 2023/0406031 A1
(43) Pub. Date: Dec. 21, 2023

(54) ADAPTIVE OBJECT SNAPPING FOR PERSPECTIVE IMAGES

(71) Applicant: Adobe Inc., San Jose, CA (US)

(72) Inventors: Ashish JAIN, Delhi (IN); Arushi JAIN, Delhi (IN)

(73) Assignee: Adobe Inc., San Jose, CA (US)

(21) Appl. No.: 17/841,569

(22) Filed: Jun. 15, 2022

(51) Int. Cl. B43L 13/14

(52) U.S. Cl. CPC B43L 13/141; B43L 13/149

(57) ABSTRACT

Embodiments are disclosed for perspective object snapping. The method may include detecting a first object in a perspective image that includes one or more vanishing points. The method may further include receiving a second object for insertion into the perspective image. The method may further include extracting a plurality of line segments from the first object. The method may further include generating, from the plurality of line segments, one or more snap points. The method may further include generating a perspective bounding box for the second object based on the one or more snap points, the one or more line segments and the one or more vanishing points. The method may further include inserting the second object into the perspective image based on the perspective bounding box.

### BACKGROUND

Perspective drawings provide a way to create a linear illusion that represents a three-dimensional visual content in a two-dimensional image. Positioning objects in a perspective image that has one or more vanishing points is one of the most challenging aspects of working in perspective images. Inserting objects accurately into perspective images presents challenges because a perspective grid has vanishing points which result in angled line segments for objects in the perspective image. Handling the angled line segments for objects present further challenges with aligning objects in the scene as some objects do not match up to a typical perspective grid. These challenges often results in inaccurate representation of objects in the perspective image.

### SUMMARY

Introduced here are techniques/technologies that relate to snapping and alignment of objects in a perspective image using line segments extracted from existing objects. In particular, the characteristics of an object added to the perspective drawing are used to align later-added objects. For example, the electronic drawing system extracts snappable line segments from bounding boxes of objects that are included in an image that has a perspective element (e.g., one or more vanishing points). By using the bounding boxes of the existing objects, the electronic drawing system provides automatic perspective snapping of new objects to the nearest line segment of a bounding box.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of perspective object snapping in accordance with one or more embodiments;

FIG. 2 illustrates an example of a perspective image including a perspective grid in accordance with one or more embodiments;

FIG. 3 illustrates an example of generating a perspective bounding box in accordance with one or more embodiments;

FIG. 4 depicts an example of computing a tolerance angle that defines a number of bins in accordance with some embodiments;

FIG. 5 illustrates an example of diminishing tolerance in accordance with one or more embodiments;

FIG. 6 illustrates an example of object to object snapping in accordance with one or more embodiments;

FIG. 7 illustrates a schematic diagram of an electronic drawing system in accordance with one or more embodiments;

FIG. 8 illustrates a flowchart of a series of acts in a method of perspective object snapping in accordance with one or more embodiments;

FIG. 9 illustrates a schematic diagram of an exemplary environment in which the electronic drawing system can operate in accordance with one or more embodiments; and

FIG. 10 illustrates a block diagram of an exemplary computing device in accordance with one or more embodiments.

### DETAILED DESCRIPTION

One or more embodiments include an electronic drawing system that generates a snapping points for inserting objects into a perspective image including at least one existing object. Drawing objects in perspective requires adapting the objects to the perspective so that the lines of the objects accurately represent the objects as well as conform to the perspective grid of the image. To do this, certain line segments of the objects must align to lines that pass through a vanishing point. However, aligning multiple objects often results in inaccurate representation of objects in the perspective image because some objects do not match up to a standard perspective grid and must be placed and aligned individually.

In an existing approach, the objects can be aligned strictly to the perspective grid lines of the perspective image. However, this approach does not have the flexibility to align objects to each other without manually adjusting the dimensions of the object to align to the snapping grid. This prevents the user from freely placing objects into the perspective and only allows snapping to a predefined snapping guide to existing points (not other objects).

In another approach, the objects can be aligned individually by a user's placement of each object. However, this approach is entirely dependent on the user's ability, and lacks accuracy and scalability, making it an inadequate solution for modern graphics design.

As discussed, conventional techniques lack the ability to align objects in a perspective image scene as some objects do not match up to a typical perspective grid. As a result, conventional systems produce misaligned object snapping or limit the locations to which a subsequent object can be snapped (e.g., the grid line density). Misaligned object snapping or limited object snapping are inadequate solutions for aligning objects in perspective images and result in either requiring intensive skill and effort to manually adjust the alignment or accepting an alignment that is not desirable.

To address these and other deficiencies in conventional systems, embodiments perform perspective object to perspective object snapping directly by extracting line segments from a first object in the perspective image and determining a line segment to which a second object can be snapped when inserted into the perspective image. This provides alignment at much higher density locations than the typical perspective grid and allows automatic adjustment for line segments that are in between grid line positions. Although embodiments are generally described with respect to drawings, embodiments may be used with animation, graphic editing, or manipulation of other relationships between objects in a perspective image.

For example, bounding boxes of objects in the image include line segments that define the bounding box. These lines can be extracted from each of the bounding boxes of objects that are included in the image. The line segments of the bounding boxes are used to provide snapping points for new objects being inserted into the image. Because the line segments are extracted from the bounding boxes of objects in the image, the line segments provide object to object snapping. When the new objects are inserted, certain line segments of the newly inserted object are adjusted to be aligned to one of the line segments extracted from the bounding boxes of objects in the existing image.

Embodiments include providing real-time perspective object snapping to existing objects in a drawing. By computing the line segments of the bounding boxes, a closest line segment for snapping can be computed for a new or relocated object. The use of line segments of existing objects (i.e., not the standard perspective grid) provides a solution for aligning objects based on the existing objects in the perspective image, thus improving the accuracy of aligning objects in graphic editing applications. Additionally, the extraction of snappable line segments provides the ability to present the user with suggested snapping points that are more flexible than a standard perspective grid.

For example, in the course of editing a perspective drawing, the user can add a new object to the drawing. In conventional systems, the user would have to manually align the new object to existing objects or snap to the grid of the perspective drawing. Aspects of the present disclosure involve a user selecting a new object for inserting into the perspective image that includes existing objects. Line segments from the bounding box of the existing objects are used to snap the bounding box of the new object. The bounding box of the new object is snapped based on an intended position (e.g., a user placement) in the perspective image so that lines after insertion are parallel or collinear to one of the line segments of the existing objects. The new object is then inserted into the image using the snapped line segments as edges of the bounding box.

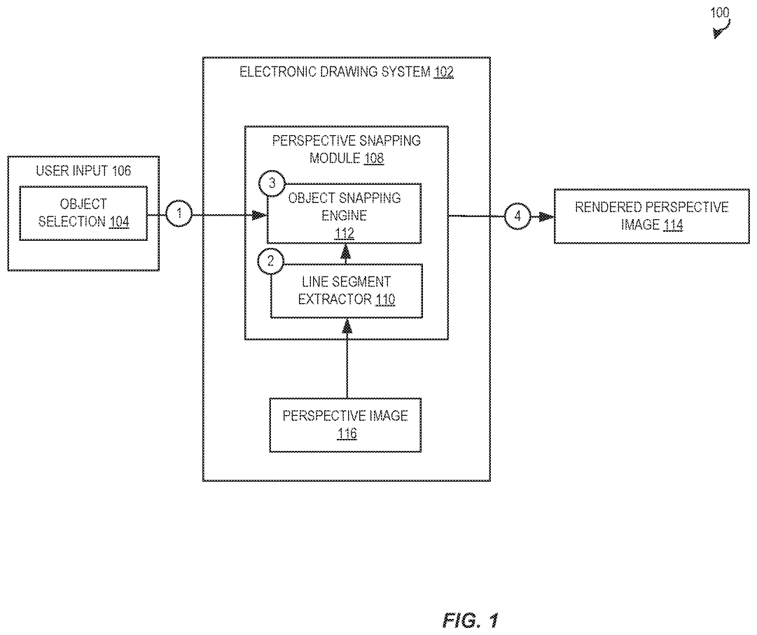

FIG. 1 illustrates a diagram 100 of a process of perspective object snapping in accordance with one or more embodiments. As depicted in FIG. 1, an electronic drawing system 102 includes a perspective snapping module 108 and a perspective image 116. The perspective snapping module includes a line segment extractor 110 and an object snapping engine 112.

The electronic drawing system 102 receives a user input 106 that includes object 104. The user input 106 is received from a user by a user interface communicatively coupled to the electronic drawing system 102. The object selection 104 can include a single object, or a series of objects that define a set of visual information. For instance, an object can be a vector graphic, a raster image, a rendered image, or other visual content. The perspective image 116 includes one or more vanishing points, a perspective grid, and one or more existing objects.

At numeral 1, the electronic drawing system 102 receives the user input 106 including the object selection 104. The user input 106 also indicates a placement location of the object selection 104. For example, the user input 106 indicates a location in the perspective image 116 that the object selection 104 is to be inserted. In some embodiments, perspective snapping module 108 is implemented as part of a graphics editing application in which the user inputs selections via touchscreen input such as by a finger or stylus. In other embodiments, the user inputs selections using an additional device such as a mouse, keyboard, etc.

At numeral 2, the line segment extractor 110 extracts one or more line segments from the perspective image 116. In some embodiments, the line segment extractor 110 extracts line segments from existing objects in the perspective image 116. The line segment extractor analyzes the perspective bounding boxes associated with each existing object and extracts the line segments that are parallel to a line that passes through the vanishing point. The line segment extractor 110 stores the line segments, such as in a non-volatile memory associated with the electronic drawing system 102. The extraction performed at numeral 2 by the line segment extractor can be performed either synchronously or asynchronously to the receiving the object selection.

At numeral 3, the object snapping engine 112 receives the object selection 104 and the output of line segment extractor 110. To insert the object selection 104 into the perspective image, the object snapping engine 112 “snaps” the object selection into the perspective image by modifying a side of the bounding box to have a slope that corresponds to a line passing through the vanishing point (e.g., one of the extracted line segments of numeral 2). To perform the snapping, the object snapping engine 113 determines a nearest line segment to the position of the side of the bounding box. At completion of numeral 3, the object selection 104 is inserted into the perspective image and becomes an object in the perspective image for rendering, output, or subsequent processing.

In one example, the object snapping engine 112 analyzes the bounding box of the object selection 104 to determine if a side of the bounding box is collinear with the one or more extracted line segments when the side of the bounding box is modified to align to a line that passes through the vanishing point. The object snapping engine 113 snaps the side of the bounding box to a point along the collinear linear segment to insert the bounding box into the perspective image. After completion of the snapping, the side of the bounding box will be positioned in the perspective image such that a common line passes through the side of the bounding box, the collinear line segment, and the vanishing point.

In another example, the object snapping engine 112 does not identify a collinear line segment for the one or more sides of the bounding box. A nearest line segment or grid line to the one or more sides is then identified by the object snapping engine. The nearest line segment is determined by comparing positions of extracted line segments with the position of the side of the bounding box. In some embodiments, the comparison can be a total point-wise distance between the extracted line segment and the side of the bounding box. In other embodiments, the comparison is made using one or more anchor points of the side of the bounding box (e.g., a start point and an end point) and searching for one of the extracted line segments that has a minimal distance between points of the extracted line segment and the one or more anchor points. The object snapping engine 112 can snap the object selection 104 to the nearest line segment.

At numeral 4, the perspective snapping module 108 outputs a rendered perspective image 114 including the object selection 104. In some embodiments, the rendered perspective image 114 is presented to the user by a screen of the electronic drawing system 102, or another visual presentation device coupled to the electronic drawing system 102.

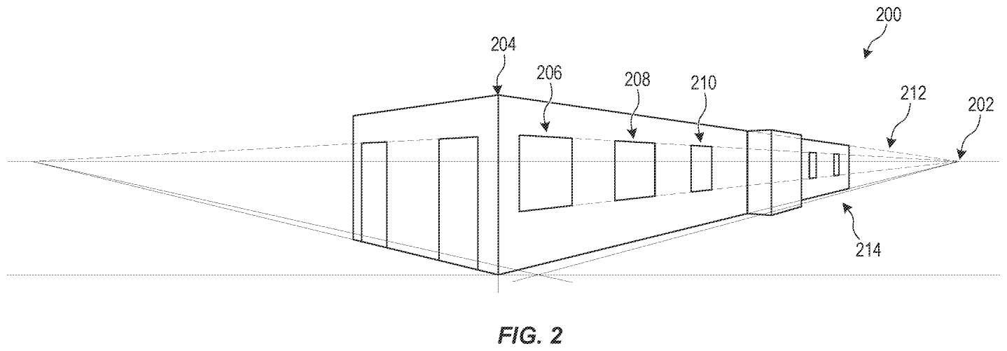

FIG. 2 illustrates an example of a perspective image including a perspective grid in accordance with one or more embodiments. The perspective image 200 includes a vanishing point 202, a first object 204, second object 206, third object 208, and fourth object 210. The perspective image 200 also includes a first line 212 and a second line 214. As will be understood by one of skill in the art, all lines representing the depth of the perspective image must pass through the vanishing point 202. For clarity, a “vanishing point” is a point in a two-dimensional perspective image where mutually parallel lines in a three-dimensional space appear to converge. To form a perspective image, the lines of a cartesian plane (prior to a vanishing point) are modified such that all lines pass through a location selected for the vanishing point.

The first object 204 that represents a building includes multiple line segments such as a top of the building that is collinear to the first line 212. The second object 206 that represents a window or other object on the right wall of the building. While the second object 206 includes four line segments, two line segments that correspond to the depth of the object such as the top side and the bottom side. Third object 208 and fourth object 210 have two line segments similar to the second object 206. As described with regard to FIG. 1, the line segment extractor identifies each of these line segments as potentially snappable segments. As additional objects are added to the perspective image 200, the process described in FIG. 1 is repeated iteratively such that the line segment extractor extracts and stores line segments available for snapping the subsequent object.

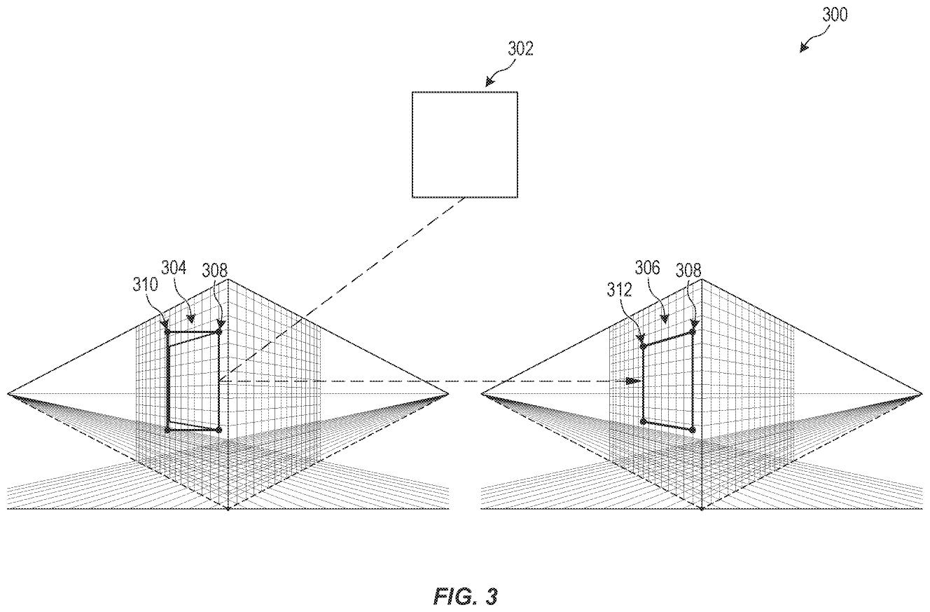

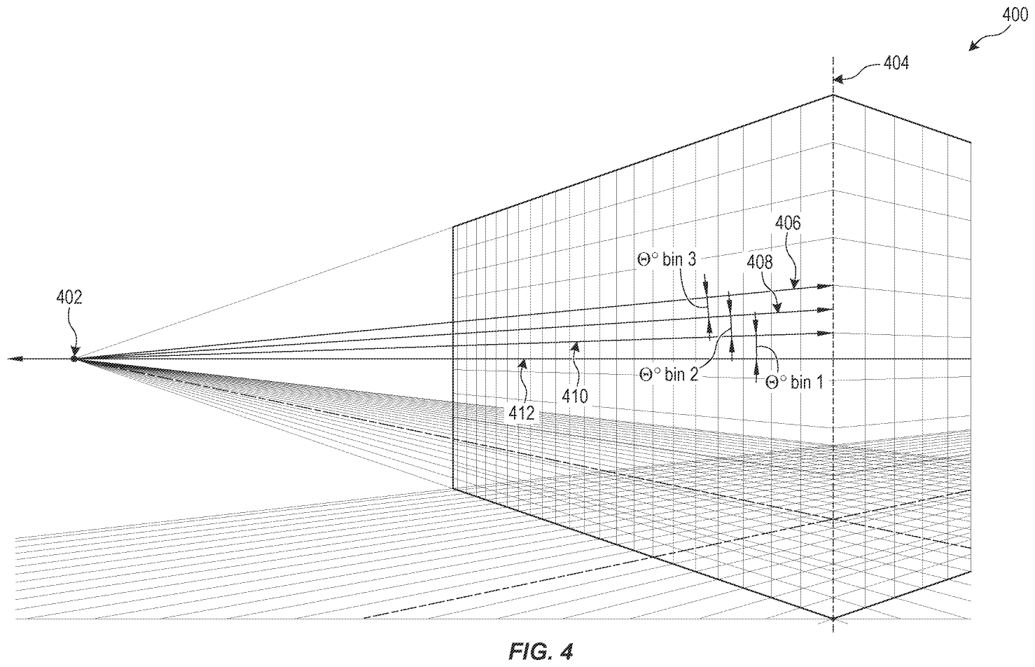

For example, the first object 204 can be added to the perspective image 200 using a traditional perspective grid snapping. The second object 206 can be added using embodiments disclosed herein and snap to either the traditional perspective grid, any line segment extracted from the first object 204, or any bin reference line (or interpolation thereof). A bin reference line is a predetermined line segment that passes through the vanishing point 202 and defines a region (i.e., a “bin”) between another bin reference line that has a different slope. Each bin reference line has a constant angular distance to the nearest bin reference line, which provides for proper snapping even in an example where a nearest extracted line segment is not usable (e.g., the nearest line segment exceeds a threshold distance from the side of the bounding box of the second object). Additional details of bin reference lines are described with regard to FIG. 4. In some embodiments, the electronic drawing system will determine a placement location of the second object 206 and identify a nearest line segment to snap to. Additional details with regard to line segments of the second object are described at least with respect to FIG. 3.

FIG. 3 depicts an example of generating a perspective bounding box in accordance with one or more embodiments. The electronic drawing system receives a bounding box 302 associated with an object to be inserted into the perspective image 300 that includes one or more objects. The bounding box 302 is inserted into the perspective image 300 as cartesian bounding box 304. The cartesian bounding box 304 is modified to form perspective bounding box 306 by snapping the horizontal lines of the cartesian bounding box 304 (i.e., the top and bottom) to a line segment that passes through the vanishing point 308. In some embodiments, the horizontal lines of the cartesian bounding box are snapped to of the extracted line segments, a bin reference line, or another line that passes through the vanishing point.

In the example depicted in FIG. 3, the slopes of the top line segment and the bottom line segments of the cartesian bounding box 304 are modified from a horizontal position to a position that corresponds to a line segment that passes through the vanishing point. As described above, to snap the cartesian bounding box into perspective image, one or more sides are modified to have a slope that corresponds to a line passing through the vanishing point. As illustrated by FIG. 3, a top line segment of the cartesian bounding box 304 includes a first anchor point 308 and a second anchor point 310. During the snapping, the top line segment is modified by displacing the second anchor point 310 to a perspective anchor position 312 that is on a line that passes through the first anchor point 308 and the vanishing point. The points of the top line segment between the first anchor point 308 and the second anchor point 310 are displaced to a corresponding position between the first anchor point 308 and the perspective anchor position 312. For illustrative purposes, the dashed line between the bounding box 302, the cartesian bounding box 304 and the perspective bounding box 306 represents the transformation of the object as the electronic drawing system inserts the object into the perspective image 300.

After the insertion of the object into the perspective image, the line segments of the perspective bounding box (i.e., the top line and the bottom line in this example) are stored as snappable line segments for subsequent objects that are added to the perspective image 300. After generating the perspective bounding box 306, the electronic drawing system extracts line segments from the perspective bounding box 306 and stores the locations of points in the line segments in an efficient data structure for future snapping points.

FIG. 4 depicts an example of computing a tolerance angle that defines a number of bins in accordance with some embodiments. The perspective image 400 includes a vanishing point 402 and a centerline 404. The centerline 404 represents a change in the representation of depth, such as a midpoint between two vanishing points. While a second vanishing point is not illustrated in FIG. 4, the centerline 404 is illustrated and the grid lines depict different slopes on opposite sides of the centerline 404 to represent different vanishing points. The perspective image includes a grid of lines that connect the centerline 404 to the vanishing point 402.

Because the grid lines have a common point on one side of the centerline 404 (i.e., the vanishing point 402), as the grid converges, the distance between the lines decreases. As the grid lines become very close to each other near a vanishing point, conventional approaches to tolerance (i.e., a linear distance tolerance) will identify too many candidate snapping lines, leading to incorrect snapping. To compensate for the distance between the lines decreasing, the electronic drawing system applies a constant angular tolerance which provides a diminishing linear tolerance such that while the linear distance between lines decreases, the angle between lines is maintained. By using the constant angular tolerance, the electronic drawing system provides precision snapping at all points including points adjacent to the vanishing point.

In some embodiments, the electronic drawing system generates a number of bins that are regions bounded by two bin reference lines with each bin reference line separated by the constant angular tolerance. The bin reference lines are used as line segments available for snapping and to validate that extracted line segments are within a threshold distance of the line segment being snapped. The electronic drawing system uses the number of bins to define the angular distance between each of the first bin reference line 410, second bin reference line 408, and third bin reference line 406.

The object snapping engine computes a slope for each bin reference line using a product of an index from the central reference line 412 and the constant angular tolerance between bins. The object snapping engine can adjust a slope of a selected line segment from a plurality of line segments of the second object (e.g., a top side of the bounding box) using the slope of the bin reference line nearest to the selected line segment. By applying the angular tolerance, the linear distance for each bin reduces as the bin reference lines approach the vanishing point, however, snapping using the constant angular tolerance continues to produce precise snapping due to the constant angular tolerance between the bin reference lines. In some embodiments, the object snapping engine can interpolate a slope of a line segment of the second object that is disposed between bin reference lines during snapping if the nearest extracted line segment exceeds the threshold distance from the line segment being snapped. For this case, the object snapping engine interpolates the line segment to maintain a constant angular distance between the line segment of the second object and each of the bin reference lines.

The electronic drawing system can predefine a total number of bins based on snapping tolerance which represents the angular distance between the bin lines (e.g., a bin width). By using the angular tolerance to define the bins, the electronic drawing system provides a robust snapping solution that validates snapping locations for a line segment. The electronic drawing system uses angular tolerance to find whether any side of the object is in line within one tolerance angle (a bin width) of any snappable location. After determining that a snappable location is within one bin width of the line segment being snapped, the electronic drawing system snaps the object to the snappable location. By validating that the snappable location is within one bin width of the line segment, the electronic drawing system prevents incorrect snapping of a line segment.

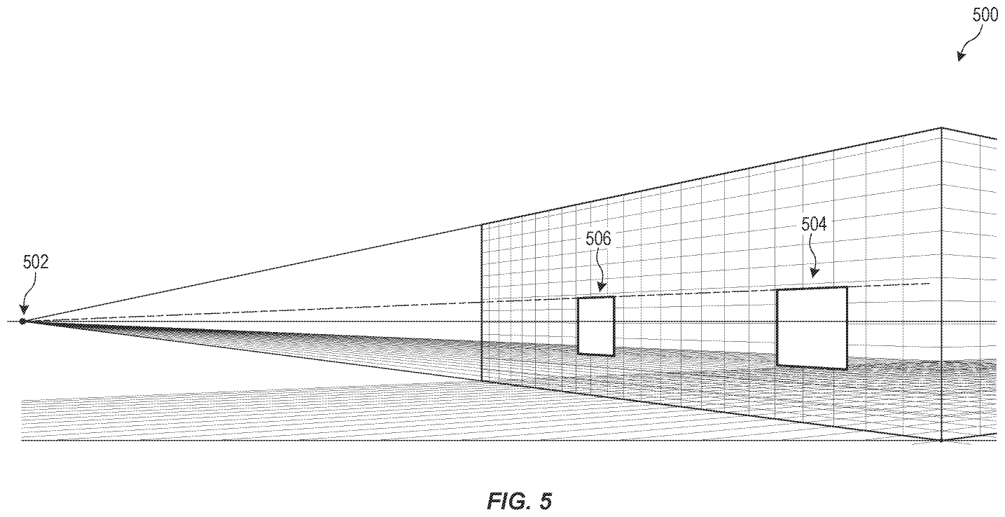

FIG. 5 illustrates an example of object to object snapping in accordance with one or more embodiments. A perspective image 500 includes a vanishing point 502, a first object 504 and a second object 506. As illustrated in FIG. 5, the first object 504 is disposed slightly below a line of the perspective grid line. As described with regard to FIGS. 1-4, line segments are extracted from the first object 504 as potentially snappable locations. In this example, the top and bottom of the first object 504 are extracted. The second object 506 is received after the placement of the first object 504. The electronic drawing system detects the position information associated with the second object (illustrated by presenting the position of the object in a user interface) to determine candidate snap points.

As illustrated in FIG. 5, the second object 506 is placed in a position with respect to the perspective grid lines and the first object 504. In this example, the electronic drawing system determines that the line segment corresponding to the top of the first object 504 is collinear with the top of the second object 506. The perspective snapping module snaps the second object by identifying horizontal line segments of the bounding box for the second object and modifies each of the horizontal line segments. The horizontal line segments are modified by changing the slope of the horizontal line segment to a slope parallel to a nearest line segment that passes through the snap point and the vanishing point. Some examples of the nearest line segment include but are not limited to a line segment of an existing object or a bin reference line.

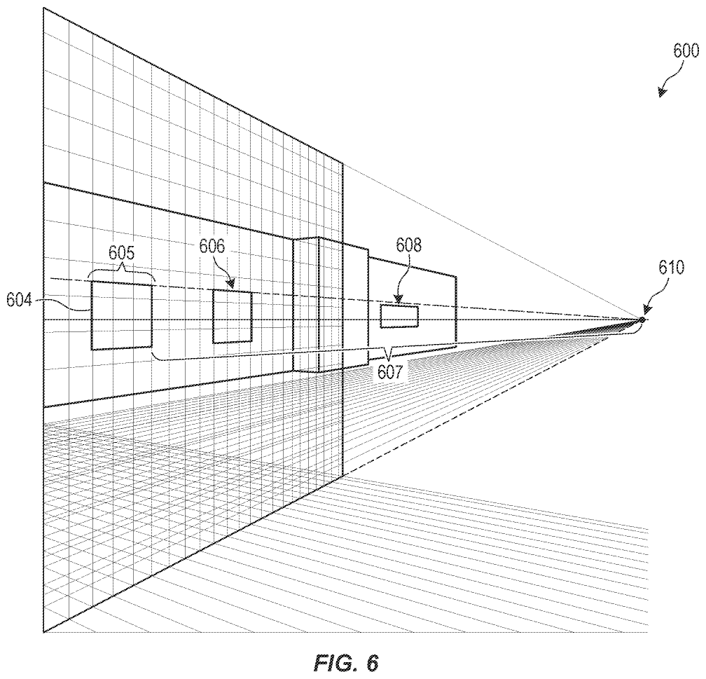

FIG. 6 illustrates an example of object to object snapping in accordance with one or more embodiments. As illustrated in FIG. 6, perspective image 600 includes a first object 604 that includes a line segment 605. As described above, the line segment 605 is extracted from the first object 604. The line segment extractor can determine the slope of an extended portion 607 of the line segment 605 that passes through the vanishing point 610. As described above, the object snapping engine detects positions of subsequent objects placed into the perspective image for snap points. In this example, the line segment 605 and the extended portion 607 include a plurality of snap points along the line segment 605 or the extended portion 607. A second object 606 is received by the electronic drawing system. The object snapping engine analyzes potential snap points of the perspective grid and snap points of the line segment 605 or the extended portion 607. The object snapping engine identifies a closest snap point, which in this example is the extended portion 607. The electronic drawing system manipulates a bounding box of the second object 606 using the extended portion 607. The electronic system adjusts the top line of the bounding box to snap the second object 606 in a position where the top line of the bounding box is collinear with the extended portion 607.

Also illustrated in FIG. 6 is a third object 608. As discussed above, the electronic drawing system can identify more than one object existing in the perspective image prior to receiving the second object. The electronic drawing system can extract the line segments of both the first object 604 and the third object 608. In this example, the second object 606 is snapped to a top line segment extracted from the first object 604 instead of the top line of segment extracted from the third object 608 which is positioned lower than the top line segments of the first object and second object. For instance, the electronic drawing system receives a location, such as indicated by a cursor position, which is closer to the top line segment of the first object 604 than the top line segment of the third object 608.

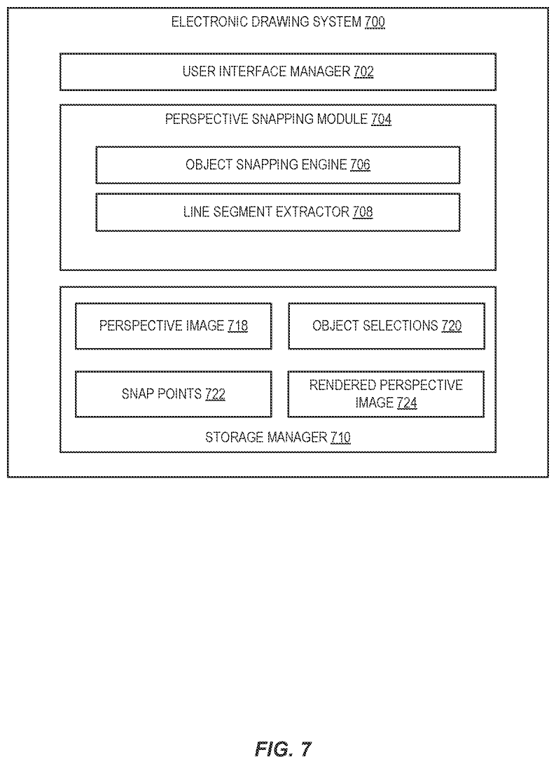

FIG. 7 illustrates a schematic diagram of electronic drawing system 700 in accordance with one or more embodiments. As shown, electronic drawing system 700 may include, but is not limited to, a user interface manager 702, a perspective snapping module 704, and a storage manager 710. The perspective snapping module 704 includes object snapping engine 706 and line segment extractor 708. The storage manager 710 includes perspective image 718, object selections 720, snap points 722, and rendered perspective image 724.

As illustrated in FIG. 7, the electronic drawing system 700 includes a user interface manager 702. For example, the user interface manager 702 allows users to provide a selection of an object to insert into a perspective drawing by the electronic drawing system 700. In some embodiments, the user interface manager 702 provides a user interface through which the user interacts with a perspective image and objects. Alternatively, or additionally, the user interface may enable the user to select a group of objects, either by providing an address (e.g., a URL or other endpoint) associated with the remote file or connecting to a remote storage (e.g., cloud storage) that includes the group of objects. In some embodiments, the user interface manager 702 enables the user to select an object or group of objects for insertion into the perspective drawing.

As illustrated in FIG. 7, the electronic drawing system 700 includes a perspective snapping module 704. The perspective snapping module 704 is a submodule of the electronic drawing system that includes an object snapping engine 706 and a line segment extractor 708. The perspective snapping module 704 can be a software application, a service accessed in a cloud computing application, or an executable module that can be downloaded to a user device.

As illustrated in FIG. 7, the electronic drawing system 700 includes an object snapping engine 706. The object snapping engine 706 is configured to receive objects, multiple line segments extracted from existing objects, and parameters of a perspective grid such as vanishing point and a perspective grid. The object snapping engine locates an intended position of a point of the second object (e.g., a cursor location or a radius around a cursor location). The object snapping engine determines if one or more sides of the bounding box for the second object is collinear with any of the line segments identified by the line segment extractor. In some embodiments, the object snapping engine identifies a nearest line segment or grid line to the one or more sides of the bounding box. The object snapping module can snap the second object to the nearest line segment. The nearest line segment is used by the object snapping engine to modify the bounding box of the second object to have a slope that is parallel or collinear to the nearest line segment.

As illustrated in FIG. 7, the electronic drawing system 700 includes a line segment extractor 708. The line segment extractor 708 can be an object segmentation process that identifies lines between a pair of vertices of an object. The line segment extractor 708 can identify multiple line segments for each object based on the visual parameters of each object. In some examples, the line segment extractor 708 can filter the identified line segments to horizontal, vertical, or oblique lines as needed for the particular perspective image. For instance, the line segment extractor 708 can apply a filter depending on locations of the vanishing points, the distance between the central reference line and the vanishing point, and other factors.

As illustrated in FIG. 7, the electronic drawing system 700 also includes the storage manager 710. The storage manager 710 maintains data for the electronic drawing system 700. The storage manager 710 can maintain data of any type, size, or kind as necessary to perform the functions of the electronic drawing system 700. The storage manager 710, as shown in FIG. 7, includes the perspective image 718. The perspective image 718 is an image that includes one or more vanishing points. A perspective image 718 has a visual appearance of depth by down scaling the objects in the image as the distance between the objects and one of the vanishing points decreases. In other words, dimensions of an object along a line that passes through the vanishing point are less than the dimensions of the object that are farther from the vanishing point.

As further illustrated in FIG. 7, the storage manager 710 also includes object selections 720. The object selections 720 can include vector objects, or other graphical information that indicates location, shape, bounding box, or other information about the objects of the perspective image. The object selections 720 can include existing objects in the perspective image and can be adjusted to include subsequently inserted objects.

The storage manager 710 may also include snap points 722. The snap points 722 can include any number of locations, or a set of locations along each of the line segments, extended portions, or bin reference lines. The snap points can be stored as a set of points or a vector indicating location information that provides the discrete locations that are available for use in object snapping.

The storage manager 710 may also include rendered perspective image 724. The rendered perspective image includes the first object, the inserted second object, and any subsequently inserted objects. In some embodiments, the rendered perspective image 114 is presented to the user by a screen of the electronic drawing system 102, or another visual presentation device coupled to the electronic drawing system 102.

Each of the components 702-710 of the electronic drawing system 700 and their corresponding elements (as shown in FIG. 7) may be in communication with one another using any suitable communication technologies. It will be recognized that although components 702-710 and their corresponding elements are shown to be separate in FIG. 7, any of components 702-710 and their corresponding elements may be combined into fewer components, such as into a single facility or module, divided into more components, or configured into different components that may serve a particular embodiment.

The components 702-710 and their corresponding elements can comprise software, hardware, or both. For example, the components 702-710 and their corresponding elements comprise one or more instructions stored on a computer-readable storage medium and executable by processors of one or more computing devices. When executed by the one or more processors, the computer-executable instructions of the electronic drawing system 700 cause a client device and/or a server device to perform the methods described herein. Alternatively, the components 702-710 and their corresponding elements can comprise hardware, such as a special purpose processing device to perform a certain function or group of functions. Additionally, the components 702-710 and their corresponding elements can comprise a combination of computer-executable instructions and hardware.

Furthermore, the components 702-710 of the electronic drawing system 700 may, for example, be implemented as one or more stand-alone applications, as one or more modules of an application, as one or more plug-ins, as one or more library functions or functions that may be called by other applications, and/or as a cloud-computing model. Thus, the components 702-710 of electronic drawing system 700 may be implemented as a stand-alone application, such as a desktop or mobile application. Furthermore, the components 702-710 of the electronic drawing system 700 may be implemented as one or more web-based applications hosted on a remote server. Alternatively, or additionally, the components of the electronic drawing system 700 may be implemented in a suit of mobile device applications or “apps.”

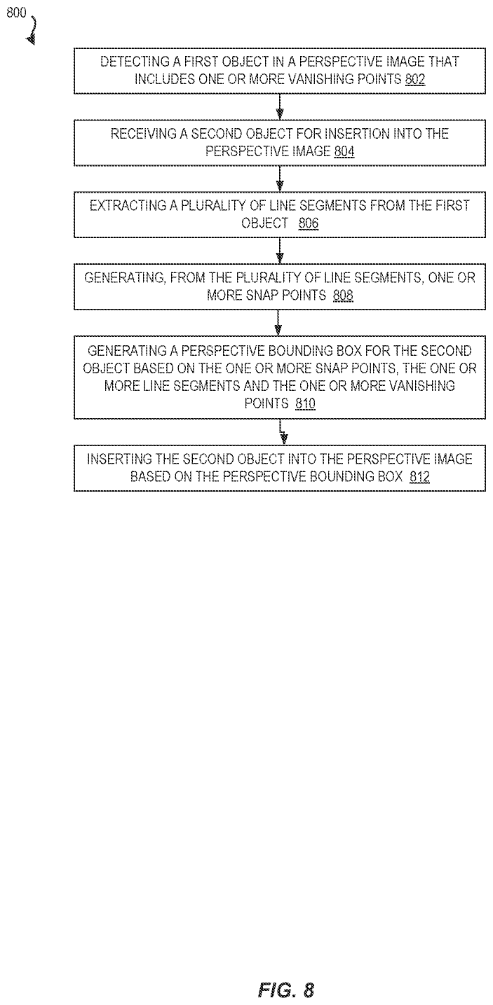

FIGS. 1-7, the corresponding text, and the examples, provide a number of different systems and devices that insert objects into a perspective image with multiple snap points. In addition to the foregoing, embodiments can also be described in terms of flowcharts comprising acts and steps in a method for accomplishing a particular result. For example, FIG. 8 illustrates a flowchart of an exemplary method in accordance with one or more embodiments. The method described in relation to FIG. 8 may be performed with fewer or more steps/acts or the steps/acts may be performed in differing orders. Additionally, the steps/acts described herein may be repeated or performed in parallel with one another or in parallel with different instances of the same or similar steps/acts.

FIG. 8 illustrates a flowchart 800 of a series of acts in a method of inserting objects into a perspective image. In one or more embodiments, the method 800 is performed in a digital medium environment that includes the electronic drawing system 700. The method 800 is intended to be illustrative of one or more methods in accordance with the present disclosure and is not intended to limit potential embodiments. Alternative embodiments can include additional, fewer, or different steps than those articulated in FIG. 8.

As illustrated in FIG. 8, the method 800 includes an act 802 of detecting a first object in a perspective image that includes one or more vanishing points. The electronic drawing system may include a perspective image that includes multiple objects. The electronic drawing system accesses the perspective image using the storage manager and detects one or more objects in the perspective image. A first object is selected from the one or more objects in the perspective image.

In some embodiments, the method 800 can include an act 804 of receiving a second object for insertion into the perspective image. The electronic drawing system can receive a user selection that includes a second object. The second object can be any graphics object that is selected for insertion into the perspective image. For example, the second object is received based on a user selection, or by accessing a library of objects.

In some embodiments, the method 800 can include an act 806 of extracting a plurality of line segments from the first object. The electronic drawing system can use the line segment extractor to determine one or more line segments of the first object which can be extended to pass through the vanishing point (e.g., horizontal lines of a cartesian bounding box that are adjusted into the perspective image). The line segment extractor extracts multiple line segments from the first object in the perspective image. As described above, the first object can be any object in the perspective image which exists with the perspective image prior to receiving the second object. In some examples, the electronic drawing system can extract multiple sets of line segments from multiple existing objects, any of which can be designated as the first object based on an intended location of the second object. For multiple objects that exist, the line segment extractor analyzes each of the perspective bounding boxes associated with each of the existing objects to determine a number of segments that could be extended such that the extended portion passes through the vanishing point.

In some embodiments, the method 800 can include an act 808 of generating one or more snap points from the plurality of line segments. For example, the electronic drawing system can choose any number of discrete points (e.g., a particular location) along each of the plurality of line segments to designate as snap points. The electronic drawing system can compute the locations of the snap points by computing a set of points through which the line segment or the extended portion between the line segment and the vanishing point passes. Each of the snap points can provide a discrete location that is available for use in object snapping.

In some embodiments, the method 800 can include an act 810 of generating a perspective bounding box for the second object based on the one or more snap points, the one or more line segments and the one or more vanishing points. For example, the electronic drawing system may manipulate a cartesian bounding box of the second object such that one line segment of the perspective bounding box has an extended portion that passes through the vanishing point.

In some embodiments, the method 800 can include an act 812 of inserting the second object into the perspective image based on the perspective bounding box. The electronic drawing system can add the visual attributes (e.g., colors, shading) of the second object into the perspective image within the perspective bounding box.

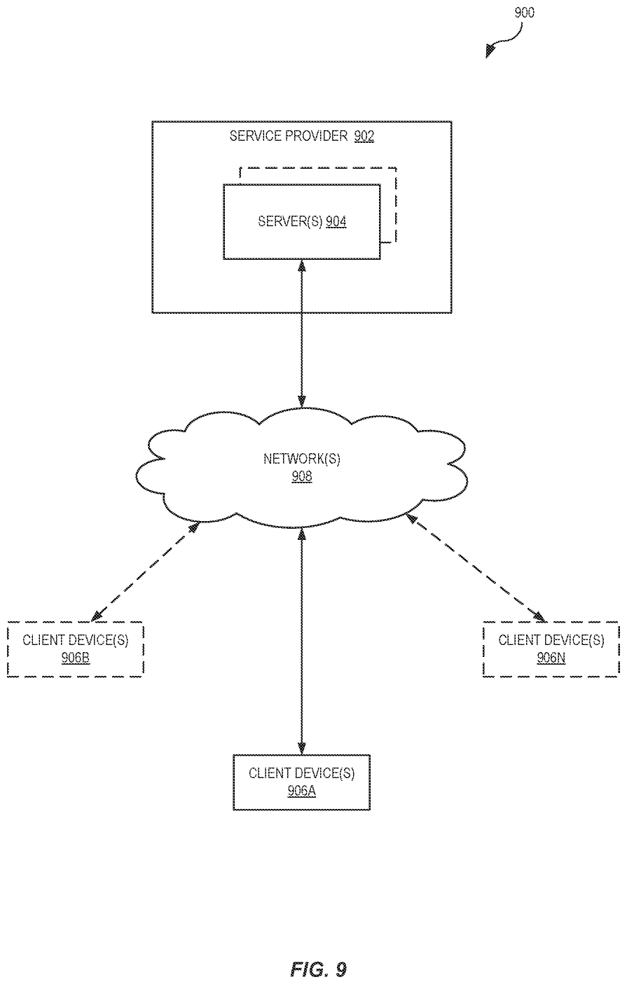

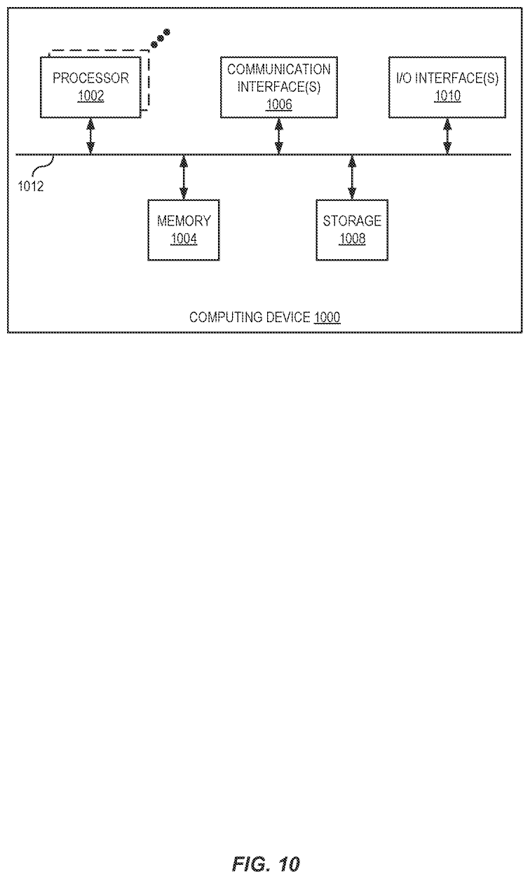

FIG. 9 illustrates a schematic diagram of an exemplary environment 900 in which the electronic drawing system 700 can operate in accordance with one or more embodiments. In one or more embodiments, the environment 900 includes a service provider 902 which may include one or more servers 904 connected to a plurality of client devices 906A-906N via one or more networks 908. The client devices 906A-906N, the one or more networks 908, the service provider 902, and the one or more servers 904 may communicate with each other or other components using any communication platforms and technologies suitable for transporting data and/or communication signals, including any known communication technologies, devices, media, and protocols supportive of remote data communications, examples of which will be described in more detail below with respect to FIG. 10.

Although FIG. 9 illustrates a particular arrangement of the client devices 906A-906N, the one or more networks 908, the service provider 902, and the one or more servers 904, various additional arrangements are possible. For example, the client devices 906A-906N may directly communicate with the one or more servers 904, bypassing the network 908. Or alternatively, the client devices 906A-906N may directly communicate with each other. The service provider 902 may be a public cloud service provider which owns and operates their own infrastructure in one or more data centers and provides this infrastructure to customers and end users on demand to host applications on the one or more servers 904. The servers may include one or more hardware servers (e.g., hosts), each with its own computing resources (e.g., processors, memory, disk space, networking bandwidth, etc.) which may be securely divided between multiple customers, each of which may host their own applications on the one or more servers 904. In some embodiments, the service provider may be a private cloud provider which maintains cloud infrastructure for a single organization. The one or more servers 904 may similarly include one or more hardware servers, each with its own computing resources, which are divided among applications hosted by the one or more servers for use by members of the organization or their customers.

Similarly, although the environment 900 of FIG. 9 is depicted as having various components, the environment 900 may have additional or alternative components. For example, the environment 900 can be implemented on a single computing device with the electronic drawing system 700. In particular, the electronic drawing system 700 may be implemented in whole or in part on the client device 902A.

As illustrated in FIG. 9, the environment 900 may include client devices 906A-906N. The client devices 906A-906N may comprise any computing device. For example, client devices 906A-906N may comprise one or more personal computers, laptop computers, mobile devices, mobile phones, tablets, special purpose computers, TVs, or other computing devices, including computing devices described below with regard to FIG. 10. Although three client devices are shown in FIG. 9, it will be appreciated that client devices 906A-906N may comprise any number of client devices (greater or fewer than shown).

Moreover, as illustrated in FIG. 9, the client devices 906A-906N and the one or more servers 904 may communicate via one or more networks 908. The one or more networks 908 may represent a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. Thus, the one or more networks 908 may be any suitable network over which the client devices 906A-906N may access service provider 902 and server 904, or vice versa. The one or more networks 908 will be discussed in more detail below with regard to FIG. 10.

In addition, the environment 900 may also include one or more servers 904. The one or more servers 904 may generate, store, receive, and transmit any type of data, including perspective images 718, object selections 720, snap points 722, rendered perspective image 724, or other information. For example, a server 904 may receive data from a client device, such as the client device 906A, and send the data to another client device, such as the client device 902B and/or 902N. The server 904 can also transmit electronic messages between one or more users of the environment 900. In one example embodiment, the server 904 is a data server. The server 904 can also comprise a communication server or a web-hosting server. Additional details regarding the server 904 will be discussed below with respect to FIG. 10.

As mentioned, in one or more embodiments, the one or more servers 904 can include or implement at least a portion of the electronic drawing system 700. In particular, the electronic drawing system 700 can comprise an application running on the one or more servers 904 or a portion of the electronic drawing system 700 can be downloaded from the one or more servers 904. For example, the electronic drawing system 700 can include a web hosting application that allows the client devices 906A-906N to interact with content hosted at the one or more servers 904. To illustrate, in one or more embodiments of the environment 900, one or more client devices 906A-906N can access a webpage supported by the one or more servers 904. In particular, the client device 906A can run a web application (e.g., a web browser) to allow a user to access, view, and/or interact with a webpage or web site hosted at the one or more servers 904.

Upon the client device 906A accessing a webpage or other web application hosted at the one or more servers 904, in one or more embodiments, the one or more servers 904 can provide access to one or more perspective images 718 stored at the one or more servers 904. Moreover, the client device 906A can receive a request (i.e., via user input) to insert a second object into a perspective image, which includes multiple objects, and provides the request to the one or more servers 904. Upon receiving the request, the one or more servers 904 can automatically perform the methods and processes described above to generate the rendered perspective image 724 that includes the second object inserted into the perspective image 718 that includes object selections 720 using the snap points 722. The one or more servers 904 can provide all or portions of the rendered perspective image 724, to the client device 906A for presentation to the user.

As just described, the electronic drawing system 700 may be implemented in whole, or in part, by the individual elements 902-908 of the environment 900. It will be appreciated that although certain components of the electronic drawing system 700 are described in the previous examples with regard to particular elements of the environment 900, various alternative implementations are possible. For instance, in one or more embodiments, the electronic drawing system 700 is implemented on any of the client devices 906A-N. Similarly, in one or more embodiments, the electronic drawing system 700 may be implemented on the one or more servers 904. Moreover, different components and functions of the electronic drawing system 700 may be implemented separately among client devices 906A-906N, the one or more servers 904, and the network 908.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an exemplary computing device 1000 that may be configured to perform one or more of the processes described above. One will appreciate that one or more computing devices such as the computing device 1000 may implement the electronic drawing system. As shown by FIG. 10, the computing device can comprise a processor 1002, memory 1004, one or more communication interfaces 1006, a storage device 1008, and one or more I/O devices/interfaces 1010. In certain embodiments, the computing device 1000 can include fewer or more components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1008 and decode and execute them. In various embodiments, the processor(s) 1002 may include one or more central processing units (CPUs), graphics processing units (GPUs), field programmable gate arrays (FPGAs), systems on chip (SoC), or other processor(s) or combinations of processors.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1004 may be internal or distributed memory.

The computing device 1000 can further include one or more communication interfaces 1006. A communication interface 1006 can include hardware, software, or both. The communication interface 1006 can provide one or more interfaces for communication (such as, for example, packet-based communication) between the computing device and one or more other computing devices 1000 or one or more networks. As an example, and not by way of limitation, communication interface 1006 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can comprise hardware, software, or both that couples components of computing device 1000 to each other.

The computing device 1000 includes a storage device 1008 which includes storage for storing data or instructions. As an example, and not by way of limitation, storage device 1008 can comprise a non-transitory storage medium described above. The storage device 1008 may include a hard disk drive (HDD), flash memory, a Universal Serial Bus (USB) drive or a combination of these or other storage devices. The computing device 1000 also includes one or more input or output (“I/O”) devices/interfaces 1010, which are provided to allow a user to provide input to (such as user strokes), receive output from, and otherwise transfer data to and from the computing device 1000. These I/O devices/interfaces 1010 may include a mouse, keypad or a keyboard, a touch screen, camera, optical scanner, network interface, modem, other known I/O devices or a combination of such I/O devices/interfaces 1010. The touch screen may be activated with a stylus or a finger.

The I/O devices/interfaces 1010 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1010 is configured to provide graphical data to a display for presentation to a user. The graphical data may be representative of one or more graphical user interfaces and/or any other graphical content that may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
detecting a first object in a perspective image that includes one or more vanishing points;
receiving a second object for insertion into the perspective image;
extracting a plurality of line segments from the first object;
generating, from the plurality of line segments, one or more snap points;
generating a perspective bounding box for the second object based on the one or more snap points, the plurality of line segments, and the one or more vanishing points; and
inserting the second object into the perspective image based on the perspective bounding box.

2. The method of claim 1, wherein the plurality of line segments are aligned such that an extended portion of the line segment passes through at least one snap point of the one or more snap points and selected vanishing point of the one or more vanishing points.

3. The method of claim 2 further comprising:
generating a number of bins based on an angular distance between a central reference line and each extended portion of the line segment; and
computing a slope for a bin reference line based on an index from the central reference line, wherein the slope is a product of the index and the angular distance; and
adjusting a slope of a selected line segment of the plurality of line segments based on the slope of the bin reference line nearest to the selected line segment.

4. The method of claim 3, wherein the angular distance is a constant angular distance that represents a diminishing tolerance between each bin of the number of bins.

5. The method of claim 2, wherein generating a perspective bounding box for the second object based on the one or more snap points, the plurality of line segments, and the one or more vanishing points comprises:
determining a horizontal line segment of the bounding box; and
adjusting the horizontal line segment based on the nearest snap point such that the horizontal line segment has a slope parallel to a nearest line segment of the plurality of line segments that passes through the snap point and the vanishing point.

6. The method of claim 1 further comprising:
scaling the perspective bounding box, wherein scaling comprises decreasing a dimension of the perspective bounding box as a distance between the vanishing point and the perspective bounding box decreases.

7. The method of claim 1, further comprising:
generating a snapping line from the first object that forms a line from the first object to the vanishing point;
displaying the snapping line; and
snapping the perspective bounding box to the snapping line.

8. A non-transitory computer-readable medium storing executable instructions, which when executed by a processing device, cause the processing device to perform operations comprising:
detecting a first object in a perspective image that includes one or more vanishing points;
receiving a second object for insertion into the perspective image;
extracting a plurality of line segments from the first object;
generating, from the plurality of line segments, one or more snap points;
generating a perspective bounding box for the second object based on the one or more snap points, the plurality of line segments, and the one or more vanishing points; and
inserting the second object into the perspective image based on the perspective bounding box.

9. The non-transitory computer-readable storage medium of claim 8, wherein the plurality of line segments are aligned such that an extended portion of the line segment passes through at least one snap point of the one or more snap points and a selected vanishing point of the one or more vanishing points.

10. The non-transitory computer-readable storage medium of claim 9, the instructions further causing the processing device to perform operations comprising:
generating a number of bins based on an angular distance between a central reference line and each extended portion of the line segment; and
computing a slope for a bin reference line based on an index from the central reference line, wherein the slope is a product of the index and the angular distance; and
adjusting a slope of a selected line segment of the plurality of line segments based on the slope of the bin reference line nearest to the selected line segment.

11. The non-transitory computer-readable storage medium of claim 9, wherein the instructions for generating a perspective bounding box for the second object cause the processing device to perform operations comprising:
determining a horizontal line segment of the bounding box; and
adjusting the horizontal line segment based on the nearest snap point such that the horizontal line segment has a slope parallel to a nearest line segment of the plurality of line segments that passes through the snap point and the vanishing point.

12. The non-transitory computer-readable storage medium of claim 8, the instructions further causing the processing device to perform operations comprising scaling the perspective bounding box, wherein scaling comprises decreasing a dimension of the perspective bounding box as a distance between the vanishing point and the perspective bounding box decreases.

13. The non-transitory computer-readable storage medium of claim 8, the instructions further causing the processing device to perform operations comprising:
generating a snapping line from the first object that forms a line from the first object to the vanishing point;
displaying the snapping line; and
snapping the perspective bounding box to the snapping line.

14. The non-transitory computer-readable storage medium of claim 8, wherein the first object is included within the perspective image prior to receiving the second object.

15. A system comprising:
a memory component; and
a processing device coupled to the memory component, the processing device to perform operations comprising:
extracting a plurality of line segments from a first object in a perspective image that includes a vanishing point;
receiving a second object including a bounding box;
identifying a horizontal line segment of the bounding box;
computing a distance between each line segment of the plurality of line segments and the horizontal line segment;
determining a modified slope of the horizontal line segment based on a nearest line segment, wherein the modified slope is parallel to the nearest line segment of the plurality of line segments; and
inserting the second object into the perspective image based on the modified slope.

16. The system of claim 15, wherein the nearest line segment of the plurality of line segments includes at least one snap point and passes through the vanishing point.

17. The system of claim 16, the operations further causing the processing device to perform operations comprising:
generating a number of bins that define a plurality of regions in the perspective image, wherein a bin comprises a first bin reference line and a second bin reference line that are separated by a constant angular distance; and
computing a slope for the first bin reference line or the second bin reference line based on an index from a central reference line, wherein the slope is a product of the index and the constant angular distance; and
selecting the nearest line segment from the plurality of line segments, wherein a first bin including the nearest line segment has an index adjacent to a second bin including the horizontal line segment.

18. The system of claim 15, the operations further causing the processing device to perform operations comprising scaling bounding box, wherein scaling comprises decreasing a dimension of the bounding box as a distance between the vanishing point and the bounding box decreases.

19. The system of claim 15, the operations further causing the processing device to perform operations comprising:
generating a snapping line from the first object that forms a line from the first object to the vanishing point;
displaying the snapping line; and
snapping the perspective bounding box to the snapping line.

20. The system of claim 15, wherein the plurality of line segments are aligned such that a slope of the line segment passes through the vanishing point.
